(19) United States
(12) Patent Application Publication
(10) Pub. No.: US 2008/0171111 A1
(43) Pub. Date: Jul. 17, 2008

(54) Assembly of Solid Confectionery Pieces

(76) Inventor: Akira Matsumoto, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 11/883,077

(22) PCT Filed: Feb. 1, 2006
(86) PCT No.: PCT/JP2006/301633

§ 371 Date: Aug. 28, 2007

(30) Foreign Application Priority Data
Feb. 2, 2005 (JP) 2005-026245

(51) Int. Cl. A23G 3/54

(52) U.S. Cl. 426/103

(57) ABSTRACT

An assembly of solid pieces of confectionery which is edible and can be hygienically played as a puzzle anywhere, anytime, e.g. outdoors and in cars.

The solid pieces of confectionery may be first and second candy pieces. The first candy piece 1 is formed with a through hole 2. The second candy piece 3 is a columnar one which can be snugly fitted in the through hole 2 formed in the first candy piece. The second candy piece 3′ may have a slightly larger diameter than the through hole of the first candy piece. In this case, the user can melt the surface of the second candy piece in his mouth to reduce its diameter until it can be fitted in the through hole of the first candy piece.

### TECHNICAL FIELD

This invention relates to a plurality of pieces of solid confectionery such as candy which can be put in a mouth and sucked while temporarily keeping their shapes, and more particularly an assembly of such a plurality of confectionery pieces.

### BACKGROUND ART

Generally, solid confectioneries such as cookies, biscuits, rice crackers and chocolates are produced in a wide variety of shapes and designs particularly to arouse customers' interest. That is, such confectionery pieces can be shaped not only to satisfy eating pleasure but also to serve as toys.

For example, toys made of solid pieces of confectionery are proposed in Patent document 1 in which solid pieces of confectionery such as cookies are formed into characters having various shapes and each divided into separate pieces of random shapes. Such assembling puzzles, each comprising a plurality of separate pieces, can be used as education toys which are assembled by consumers, particularly children, and are useful to improve their ability to recognize plane figures and three-dimensional arrangements while playing.

Also, a toy made of confectionery material is proposed in Patent document 2, which comprises two or more separate solid confectionery pieces and which is, when assembled, in the shape of a hamburger bun or a piece of hamburger steak.

With such known toys made of solid pieces of confectionery, children play with them, i.e. assemble them using their hands, and then eat them. In other words, assembling and eating are done as separate actions.

Patent document 1: Japanese patent publication 2002-223701A

Patent document 2: Japanese patent No. 3375138

### DISCLOSURE OF THE INVENTION

### Problems to Which the Invention Seeks a Solutions

In order to play with such conventional toys of solid confectionery pieces, it is necessary to select proper ones from among a large variety of solid confectionery pieces or replace certain pieces with other ones. For this purpose, a table or a container is necessary to store such a large variety of solid confectionery pieces. It is difficult to play with such conventional toys of solid confectionery pieces in sufficiently hygienic conditions, especially outdoors or in cars.

Also, because such solid confectioneries typically contain water-soluble sweeteners such as sugar, when brought into contact with moisture in the air or evaporated from hands, they tend to absorb such moisture, thus softening, becoming sticky and/or partially melting. This causes various bacteria to stick to the confectionery pieces, which is of course hygienically unfavorable.

Further, there was no concept of playing with such conventional toys of solid confectionery pieces using body parts other than hands. Particularly there was no idea of playing with them in the mouth.

An object of the present invention is to provide an assembly of solid confectionery pieces with which one can hygienically play puzzle practically without touching them by hand, at any time and any place, outdoors and in vehicles, and which are eatable after playing with them.

### Means to Solve the Problems

According to the present invention, there is provided a solid confectionery piece assembly comprising a plurality of solid confectionery pieces of such a size as to be put in a mouth, at least one of the confectionery pieces being formed with a recess, through hole or cutout so that one confectionery piece is partially or entirely engageable with fitted in at least one of other confectionery pieces, or the plurality of confectionery pieces are partially or entirely engageable with or fitted with one another, by means of the recess, through hole or cutout.

The solid confectionery piece assembly according to the present invention comprises a plurality of confectionery pieces which have such a total volume or size that one can put all the pieces in his or her mouth and move them freely therein. At least one of the confectionery pieces is formed with a recess, through hole, or slit, so that one confectionery piece is partially or entirely engageable with another piece, or one piece is engageable with a plurality of pieces, or a plurality of pieces are engageable with one another.

Thus, by putting two or more pieces in a mouth, moving them in the mouth as desired, and adjusting their position on the tongue, one can engage one confectionery piece with another piece or with a plurality of pieces, or engage a plurality of pieces with one another by means of the recess, hole or slit, thereby assembling the pieces or making them integral.

Since the confectionery piece assembly can be assembled in a mouth without using hand, no table, stand or container is needed unlike conventional confectionery piece puzzle using hand. No space for moving hands is needed. So one can enjoy assembling or puzzle easily at any time and any place, not only indoors but outdoors and in vehicles. Also, the confectionery piece assembly provides hygienic play means because touch with hands in play is minimum. Further, difficulty resulting from non-use of hands gives interest not only to children but to adults and provides feeling of achievement when the confectionery piece assembly has been assembled successfully.

In assembling the confectionery piece assembly by moving the solid pieces in the mouth, one can scrape the piece partially with teeth, rub it or dividing it with the tongue, melt its surface partially to decrease its size, thereby changing its shape. Therefore, even if two confectionery pieces are not engageable with each other when they are first put into the mouth, it is possible to gradually adjust or modify their shape in the mouth until they become engageable. So one can enjoy assembling in varied ways.

Among various combinations of solid confectionery pieces providing such pleasure, typical ones are a combination of a solid confectionery piece formed with a recess, through hole or slit and a solid confectionery piece formed with a protrusion or recess engageable therewith and a combination of the former and a cylindrical solid confectionery piece.

Combinations of means for engaging the confectionery pieces together include recess and protrusion, recess and cylindrical portion, through hole and protrusion, and through hole and cylindrical portion. Also, even if such confectionery pieces are not engageable with each other at first, one can engage them together by working them in the mouth with the tongue tip, particularly enlarging a recess to a through hole, increasing the diameter of a through hole, decreasing the diameter of a cylindrical portion, biting them or biting off their parts. Also, at least one of the solid confectionery pieces may be made of an elastic material so that the elastic solid piece is engageable with another solid piece by bending the former.

As other combinations of confectionery pieces, disk-like solid confectionery pieces formed with a slit may be adopted.

Such solid confectionery pieces can be engaged together by facing them perpendicularly to each other with the slits aligned with each other and inserting them toward each other until the bottoms of the slits meet.

The present invention also provides an integral assembly of a plurality of solid confectionery pieces which are integrally coupled together but separable from each other in the mouth.

The plurality of confectionery pieces forming the integral assembly can be easily separated from each other by melting, biting off, or scraping the coupling portions of the plurality of confectionery pieces in the mouth. The plurality of confectionery pieces forming the integral assembly are directly joined together or joined together through rod-shaped or otherwise shaped coupling pieces. Such an integral assembly can be formed e.g. by injection molding. Thus, such an integral assembly can be produced efficiently at a low cost.

After the plurality of solid confectionery pieces forming the integral assembly have been separated from each other, they can be joined together by fitting a protrusion or a columnar portion of one of them into a recess or a hole formed in another confectionery piece.

Typical materials of solid confectionery pieces used for solid confectionery piece assembly include candy, lemonade candy, Gummi candy, chocolate, cookies and biscuits. Also, gum, rice crackers, dry fruit and other solid confectionery may be used as the material. Different materials may be used in combination.

### Advantages of the Invention

The assembly of solid confectionery pieces according to the present invention can be put into the mouth of a human with minimum touch with hand. So the cake pieces can be assembled and disassembled hygienically while tasting the cake. Also, one can enjoy with it at any place, indoors, outdoors and in vehicles.

### BRIEF DESCRIPTION OF THE DRAWINGS

FIG. 1 are perspective views of parts of a first embodiment of the invention in exploded form;

FIG. 2 is a perspective view of a second embodiment in exploded form;

FIG. 3 are perspective views of parts of a third embodiment of the invention in exploded form;

FIG. 4 is a perspective view of a fourth embodiment in exploded form;

FIG. 5 is a perspective view of a fifth embodiment in exploded form;

FIG. 6 is a perspective view of a sixth embodiment in exploded form;

FIG. 7 is a perspective view of a seventh embodiment in exploded form;

FIG. 8 is a perspective view of an eighth embodiment in exploded form;

FIG. 9A is a perspective view of an integral assembly of a ninth embodiment;

FIG. 9B is a perspective view of the ninth embodiment when their elements are separated from each other;

FIG. 10A is a perspective view of an integral assembly of a tenth embodiment; and

FIG. 10B is a perspective view of the tenth embodiment when their elements are separated from each other.

### DESCRIPTION OF REFERENCE NUMERALS

1, 3, 3′, 17, 19: Candy pieces

2, 29, 30, 31: Through holes

4, 5: Chocolate pieces

6: Cubic hole

7, 9, 9′: Lemonade candy pieces

8, 12: Circular holes

10, 11: Gummi candy pieces

13, 14: Cookie pieces

15, 16, 18: Slits

20: Groove

21, 25, 26: Columnar pieces

22, 23: Disk-shaped pieces

22a, 23a: Circular holes

24: Ring-shaped piece

27, 28: Oval disks

32, 36: First Gummi candy pieces

33, 37: Second Gummi candy pieces

34: Coupling piece

35: Circular through hole

### BEST MODE FOR EMBODYING THE INVENTION

The embodiments of the present invention are now described with reference to the accompanying drawings.

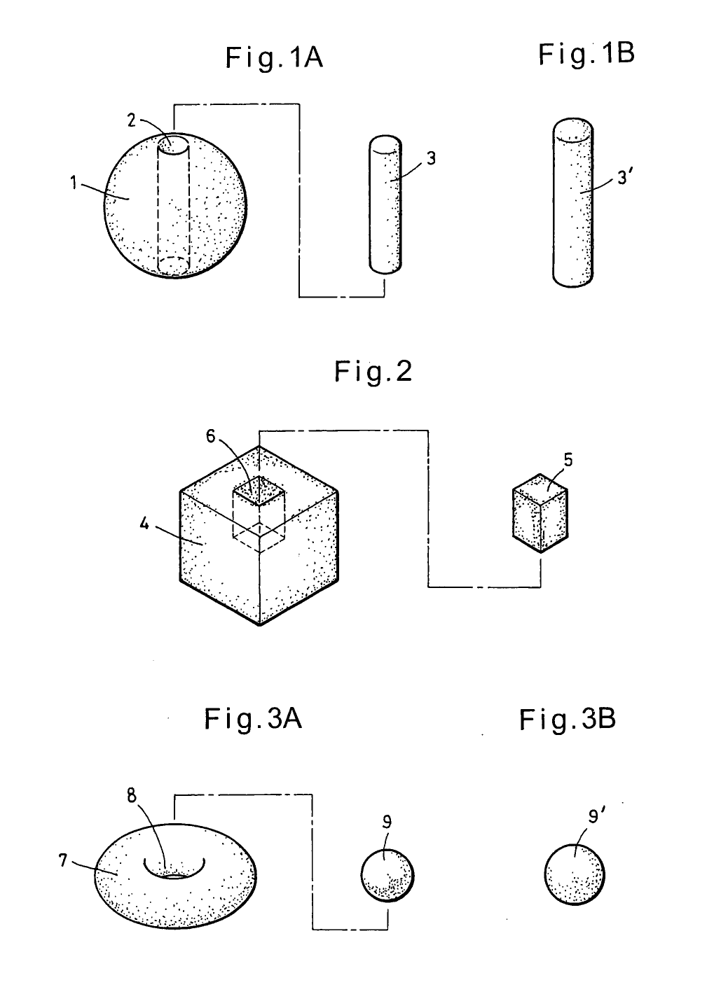

FIG. 1A shows an assembly of solid confectionery pieces of the first embodiment, which comprises a globular candy piece 1 formed with a through hole 2 and a cylindrical candy piece 3. It can be assembled by inserting the candy piece 3 into the through hole 2.

The candy piece 3 of the embodiment of FIG. 1A has a diameter substantially equal to that of the through hole 2 of the globular candy piece 1. The cylindrical candy piece 3′ of FIG. 1B has a larger diameter. In this case, the user can put it in his mouth and suck it to adjust (i.e. reduce) its diameter so that the candy piece 3′ can be inserted into the through hole 2.

The length of the cylindrical candy piece 3 is not limited, but is preferably equal to or only slightly larger than the length of the through hole 2 so that when they are assembled together, they form a substantially completely spherical body.

The candy pieces may be made by mixing known materials at a know rate. The mixture is shaped by cast-molding while the mixture is still soft, or by blanking or cutting a sheet- or rod-shaped raw material, and then hardened if necessary, to form candy pieces of desired shapes.

For example, the candy pieces may be made by dissolving sugars as main ingredients such as liquid candy or cane sugar into water, heating the mixture to melt the sugars while optionally adding milk and/or fruit juice, boiling down the mixture, molding it, and cooling it to allow it to harden.

FIG. 2 shows the second embodiment, which is an assembly of a large, substantially cubic chocolate piece 4 and a small, substantially cubic chocolate piece 5. The large cubic chocolate piece 4 has a non-through cubic hole 6 which is substantially of the same size as the chocolate piece 5 so that the chocolate piece 5 can be snugly fitted in the cubic hole 6.

The chocolate pieces are made by heating e.g. commercially available sheet chocolate to melt it, and pouring the thus molten chocolate into molds.

FIG. 3A shows the third embodiment, which is an assembly of a doughnut-shaped lemonade candy piece 7 formed with a circular, axial through hole 8 and a spherical lemonade candy piece 9 having a diameter substantially equal to the diameter of the hole 8 so that the candy piece 9 can be snugly fitted in the hole 8.

The candy piece 9 of FIG. 3B has a diameter slightly larger than the hole 8. In this case, the user can put the candy piece 9′ in his mouth, and melt it with the tongue to reduce its diameter until the candy piece 9′ can be snugly fitted into the hole 8 or can pass therethrough.

To form such lemonade candy pieces, cane sugar (or glucose) and citric acid are added to hot water to let them melt in the hot water, and then, corn starch and optionally coloring agents and flavors are added thereto. The mixture thus formed is put in molds and hardened into desired shapes, and dried at normal temperature.

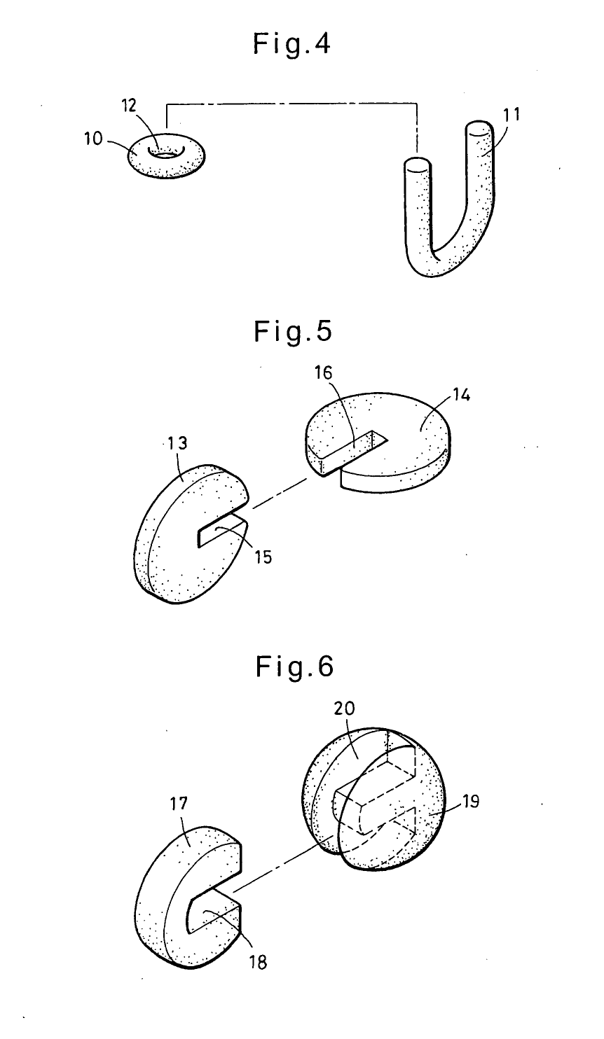

FIG. 4 shows the fourth embodiment, which is an assembly of a doughnut-shaped Gummi candy piece 10 formed with a circular, axial through hole 12, and a U-shaped Gummi candy piece 11 having a diameter which is substantially equal to the diameter of the hole 12.

One can play with it in the mouth e.g. by engaging the candy piece 10 with the U-shaped candy piece 11 at one end thereof, and sliding it over the candy piece 11 to its mid-portion or all the way to the other end of the candy piece 11 until the candy piece 10 disengages from the candy piece 11.

To form the Gummi candy pieces, citric acid is added to molten starch syrup, and then gelatin moistened with hot water is added to form a sol. The sol is poured into molds for resin or cornstarch and cooled into gelated Gummi candy pieces having desired shapes.

FIG. 5 shows the fifth embodiment, which is an assembly of a pair of disk-shaped cookie pieces 13 and 14 formed with slits 15 and 16, respectively, extending radially to the center.

The two cookie pieces 13 and 14 can be joined together by moving them toward each other with the openings of the slits 15 and 16 facing each other as shown in FIG. 5 until the end walls of the slits 15 and 16 abut each other.

FIG. 6 shows the sixth embodiment, which is an assembly of a disk-shaped candy piece 17 formed with a slit 18 extending radially to its center and a globular candy piece 19 formed with a recess 20 complementary in shape to the candy piece 17.

The candy piece 17 and the candy piece 19 can be assembled together by inserting the candy piece 17 into the recess 20 of the candy piece 19 until the end walls of the slit 18 and the recess 20 abut the candy pieces 19 and 17, respectively.

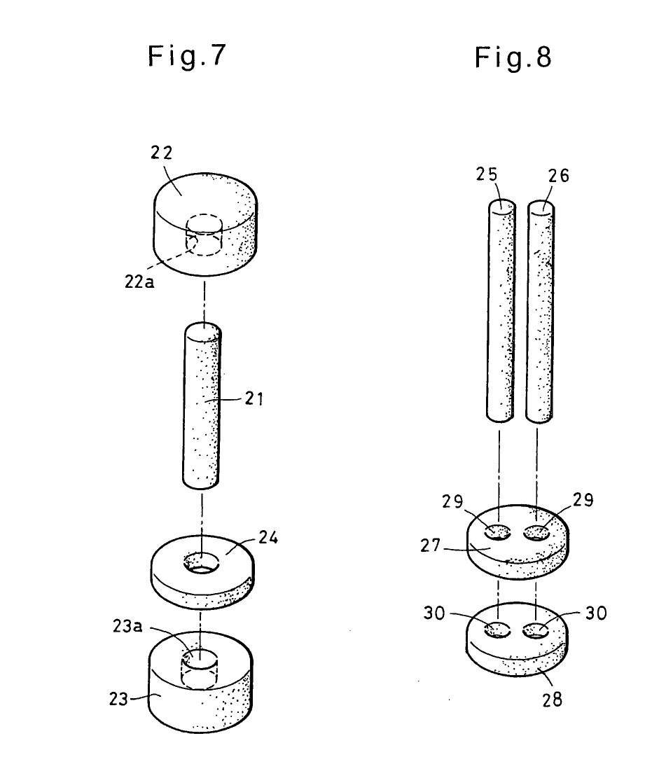

FIG. 7 shows the seventh embodiment, which is an assembly of a candy stick 21, a candy ring 24, and two candy disks 22 and 23 formed with circular recesses 22a and 23a, respectively.

It can be assembled by putting a circular hole 23a of the candy disk 23 on one end of the candy stick 21, putting the candy ring 24 on the candy stick 21, and putting a circular hole 22a of the other candy disk 22 on the other end of the candy stick 21.

FIG. 8 shows the eighth embodiment, which is an assembly of a pair of solid candy sticks 25, 26 and a pair of elliptical candy disks 27, 28 each formed with two circular holes 29, 30 of a size to receive the candy sticks 25, 26.

It can be assembled by putting the circular through holes 29 and 30 on the candy sticks 25, 26.

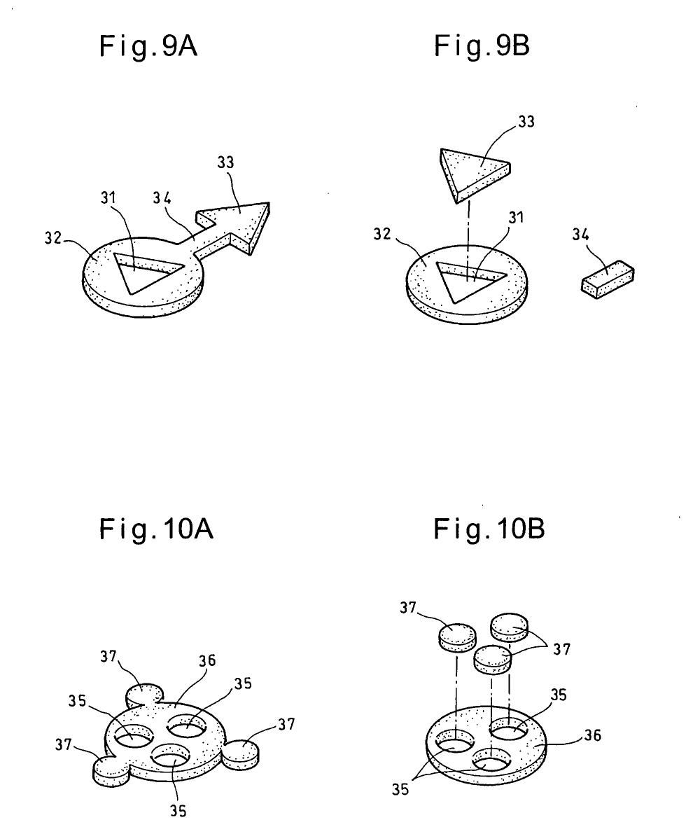

FIG. 9A and 9B show the ninth embodiment, which is an integral assembly comprising, as shown in FIG. 9A, a first disk-shaped Gummi candy piece 32 formed with a triangular through hole 31 and a second triangular flat Gummi candy piece 33 coupled to the first Gummi candy piece 32 through a square columnar coupling piece 34 made of Gummi candy.

In the mouth, the coupling piece 34 is bitten off and eaten. In this state, as shown in FIG. 9B, the second Gummi candy piece 33, which is now separated from the first Gummi candy piece 32, can be fitted in the through hole 31 of the first Gummi candy piece 32 using the tongue and/or teeth.

FIG. 10 shows the tenth embodiment, which is an integral assembly comprising, as shown in FIG. 10A, a first disk-shaped Gummi candy piece 36 formed with three circular through holes 35, and three second small disk-shaped Gummi candy pieces 37 integrally fixed to the outer edge of the first Gummi candy piece 36 by e.g. injection molding.

As shown in FIG. 10B, in the 10th embodiment, in the mouth, the second Gummi candy pieces 37 are separated from the first Gummi candy piece 36 by biting them off or by bending and breaking them off with teeth and/or the tongue. In this state, the three second Gummi candy pieces 37 can be fitted in the respective through holes 35 of the first candy piece 36.

In the ninth embodiment, a plurality of through holes 31 may be formed in the first Gummi candy piece 32 and the assembly may include as many second Gummi candy pieces 33 as the through holes 31. In the tenth embodiment, the number of the through holes 35 and the second Gummi candy pieces 37 is not limited to three and may be one. The shapes of the through holes and second Gummi candy pieces of both ninth and tenth embodiments are not limited either. For example, they may be oval or defined by any other closed curves, polygonal, or of any other known shape. They may have different sizes from each other too.

The integral assembly of either of the ninth and tenth embodiments may be combined with a ring-shaped solid confectionery piece that fits around the integral assembly. Such a ring-shaped solid confectionery may be made of a different material from the integral assembly. For example, it is a candy piece.

1. A solid confectionery piece assembly comprising a plurality of solid confectionery pieces of such a size as to be put in a mouth, at least one of the confectionery pieces being formed with a recess, through hole or cutout so that one confectionery piece is partially or entirely engageable with fitted in at least one of other confectionery pieces, or the plurality of confectionery pieces are partially or entirely engageable with or fitted with one another, by means of the recess, through hole or cutout.

2. The solid confectionery piece assembly of claim 1 comprising a solid confectionery piece formed with a recess, through hole or cutout and a solid confectionery piece formed with a protrusion or recess engageable or fittable therewith or a cylindrical solid confectionery piece.

3. The assembly of claim 1 wherein at least two of said solid confectionery pieces are integrally coupled together so as to be separable from each other in a mouth.

4. The assembly of claim 1 wherein said solid confectionery pieces are solid confectionery pieces comprising one or more confectioneries selected from candy pieces, lemonade candy pieces, Gummi candy pieces, chocolate pieces and cookie pieces.

5. The assembly of claim 2 wherein at least two of said solid confectionery pieces are integrally coupled together so as to be separable from each other in a mouth.

6. The assembly of claim 2 wherein said solid confectionery pieces are solid confectionery pieces comprising one or more confectioneries selected from candy pieces, lemonade candy pieces, Gummi candy pieces, chocolate pieces and cookie pieces.

7. The assembly of claim 3 wherein said solid confectionery pieces are solid confectionery pieces comprising one or more confectioneries selected from candy pieces, lemonade candy pieces, Gummi candy pieces, chocolate pieces and cookie pieces.
